(19) United States
(12) Patent Application Publication
(10) Pub. No.: US 2016/0361800 A1
(43) Pub. Date: Dec. 15, 2016

(54) DEVICE FOR SCREWING AND/OR UNSCREWING A THREADED FLANGE TO/FROM A THREADED END OF A CORRESPONDING TUBULAR ELEMENT

(71) Applicant: ANDEL TECHNOLOGY POLSKA SP. ZO.O., Byków (PL)

(72) Inventor: Hemanuel Piva, Bassano Del Grappa (IT)

(21) Appl. No.: 15/117,783

(22) PCT Filed: May 13, 2014
(86) PCT No.: PCT/IB2014/000729

§ 371 Date: Aug. 10, 2016

(30) Foreign Application Priority Data
Feb. 11, 2014 (IT) VE2014A000009

(51) Int. Cl. B25B 13/50; F16B 2/04

(52) U.S. Cl. CPC B25B 13/50; F16B 2/04

(57) ABSTRACT

A device for screwing and/or unscrewing a threaded flange to/from the threaded end of a corresponding tubular element includes: a plate provided with four slotted holes and a counterplate concentrically facing and abutting against the plate, provided with two shaped seats each one of which intersects a pair of slotted holes of the plate; a pair of cursors slidingly associated with each shaped seat and each comprising a pin configured so that it can be fitted through a corresponding slotted hole at the level of the area of intersection between each shaped seat and the corresponding slotted hole; counteracting elements associated with the pins and placed in contact with a spindle configured so as to move the counteracting elements radially with respect to the pins; a lock suited to lock the plate and the counterplate to each other.

The present invention concerns a device for screwing and/or unscrewing a flange to/from a corresponding tubular element.

It is known that in order to connect tubular elements that are coaxial with each other coupling flanges are used that are fixed to the ends of the tubular elements, positioned so that they face each other and connected by means of bolts

According to a known embodiment, each flange is constituted by a disc, provided with a threaded centre hole configured so that it can be screwed to a corresponding threaded portion of a tubular element, provided with a plurality of through holes arranged around the threaded hole.

By means of said flanges, therefore, it is possible to connect any number of tubular elements, one after the other, thus obtaining a continuous pipe having indefinite length.

Alternatively, the application of the flange to the end of a tubular element can serve to connect it, for example, to a tank, to a manifold and in general to any manifold body suited to contain fluids.

According to the known art, in order to connect a threaded flange to the corresponding tubular element, it is necessary to lock the latter in horizontal position between the jaws of a vice fixed to a workbench and then to screw the flange manually to the threaded end of the tubular element only for a limited portion.

If the flange is provided with a collar, the operator completes the flange screwing operation by setting the flange rotating via manoeuvring means that are constrained to the collar.

In the case where the flange is not provided with a collar, the operator completes the flange screwing operation by setting the flange rotating through a lever that is arranged crosswise between two bolts inserted in the holes provided in the flange.

The operating modes just described above are used also to unscrew flanges and in both cases these operating modes pose recognized drawbacks in terms of both the quality of the screwing and/or unscrewing work and the safety conditions in which the operation is performed.

A first drawback is constituted by the fact that the screwing systems described above are complicated and must be carried out by expert personnel.

In particular, the flange unscrewing operation requires considerable manual effort by the operator, especially when the flanges to be unscrewed are blocked by oxidation or deposits that have formed during use.

Especially in these cases, the operator actually runs the risk of being injured while unscrewing a flange, since, as already explained, the required operations are substantially manual and are carried out without using specific equipment.

Furthermore, the last but not least important drawback is constituted by the to fact that it is difficult and dangerous to screw and/or unscrew flanges to/from pipes projecting from the ceiling.

It is the object of the invention to overcome these drawbacks.

In particular, it is the object of the invention to provide a device that makes it easier and quicker to screw and unscrew a threaded flange to/from the corresponding threaded end of the respective tubular element independently of the position of said tubular element.

It is another object of the invention to provide a device that also makes said screwing and unscrewing operations safer.

The objects mentioned above are achieved by a device whose characteristics are described in the main claim, to which reference shall be made.

Other characteristics of the device that is the subject of the invention are described in the dependent claims.

A preferred embodiment of the present invention is described here below merely by way of example without limitation, making reference to the attached drawings, wherein:

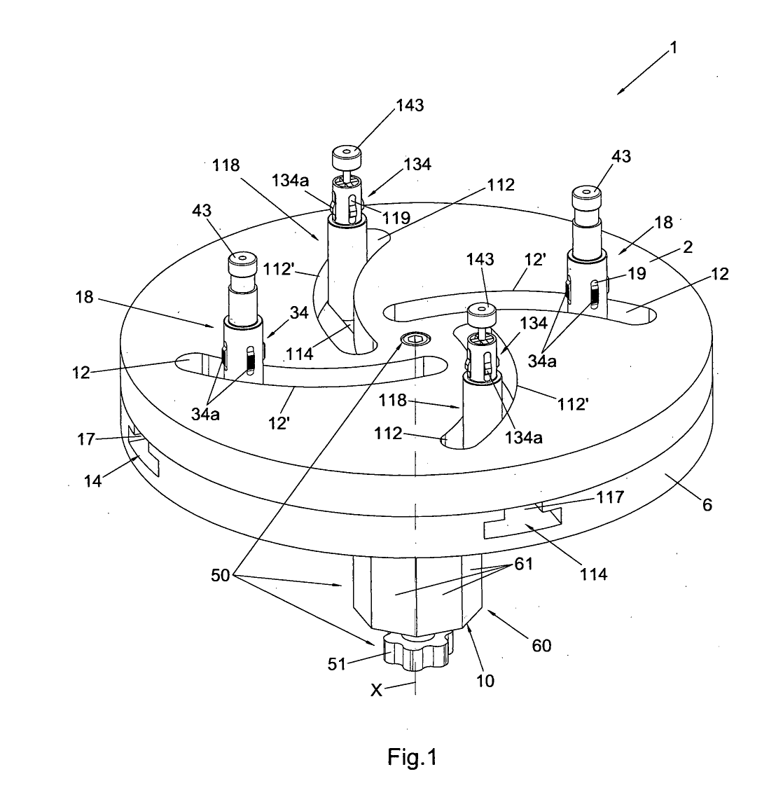

FIG. 1 shows a perspective view of the device that is the subject of the invention;

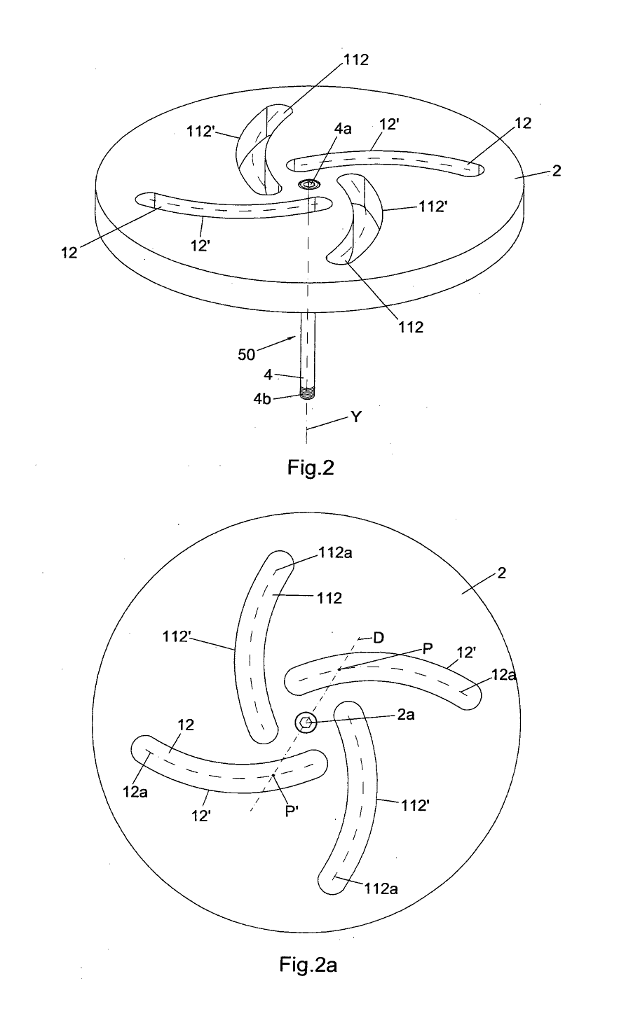

FIG. 2 shows a perspective view of a detail of FIG. 1;

FIG. 2a shows a plan view of the detail shown in FIG. 2;

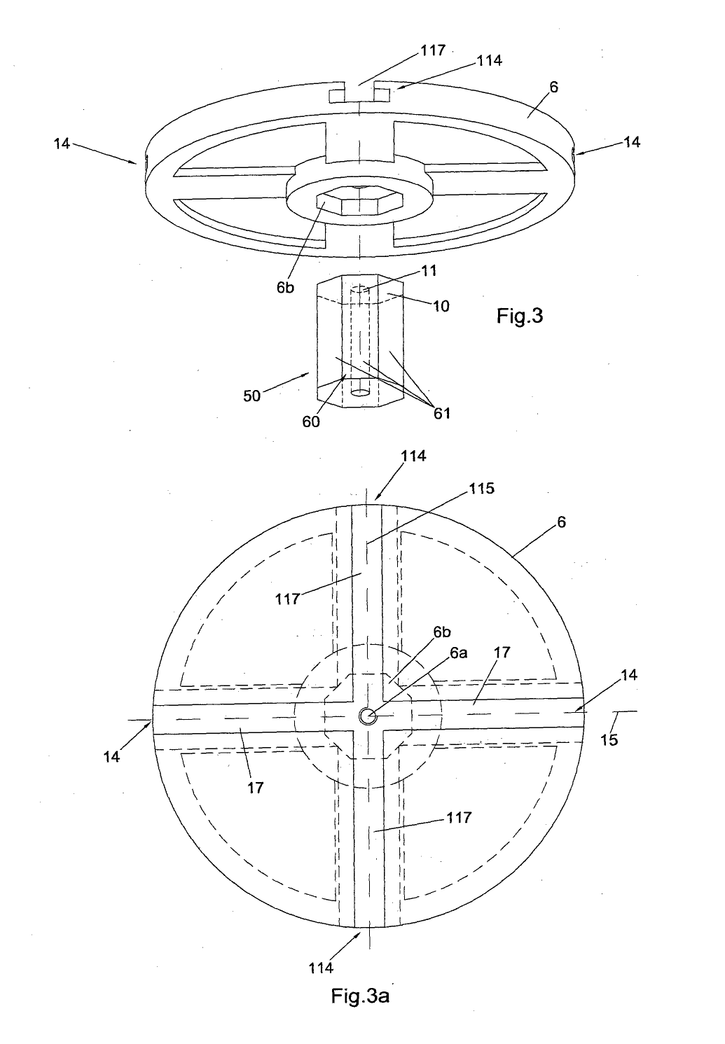

FIG. 3 shows a perspective view of another detail of FIG. 1;

FIG. 3a shows a plan view of the detail shown in FIG. 3;

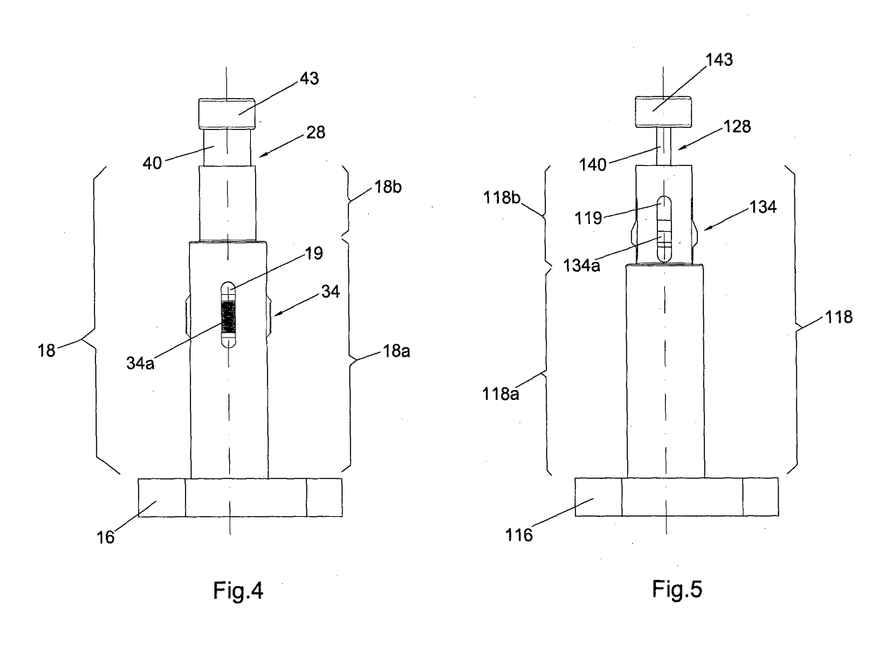

FIG. 4 shows a spindle that is visible in FIG. 1;

FIG. 5 shows another spindle that is visible in FIG. 1;

FIGS. from 6 to 8 show the longitudinal cross sections of the spindle of FIG. 4 in three different operating configurations;

FIGS. from 9 to 11 show the longitudinal cross sections of the spindle of FIG. 5 in three different operating configurations;

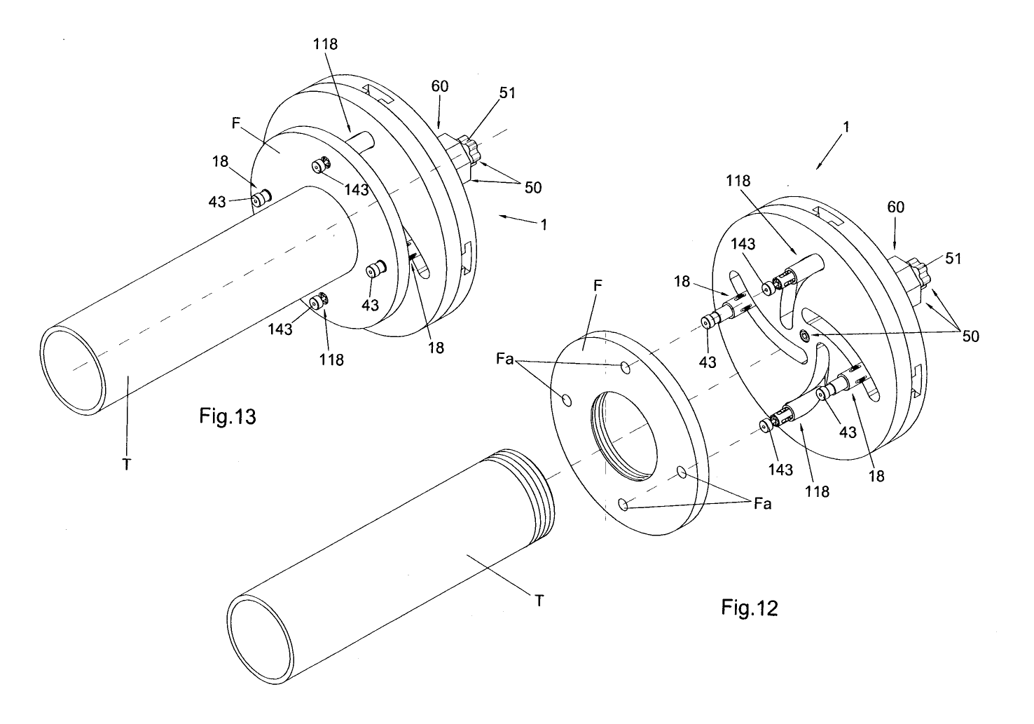

FIGS. 12 and 13 show an exploded axonometric view of the device that is the subject of the invention and of a respective flange before and while it is screwed to the corresponding tubular element.

The screwing and/or unscrewing device that is the subject of the invention is illustrated in a perspective view in FIGS. 1, 12 and 13, where it is indicated as a whole by 1.

It is used to screw and/or unscrew a threaded flange F to/from the threaded io end of a corresponding tubular element T and substantially comprises a plate 2 provided with at least one pair of slotted holes 12; 112, concentrically superimposed to and abutting against a counterplate 6 provided with at least one shaped seat 14; 114.

The plate 2 and the counterplate 6 are preferably but not necessarily shaped as a disc and are thus circular in shape, as shown in FIGS. 2, 2a, 3 and 3a.

Furthermore, for safety reasons and in order to avoid the presence of projecting parts, the discs that constitute the plate 2 and the counterplate 6 have the same diameter.

It is understood, in any case, that the plate 2 and the counterplate 6 can have any shape, for example the shape of a prism.

With regard to the plate 2, in each one of the slotted holes 12; 112 it is possible to identify a centre line 12a; 112a defined by a plurality of points, wherein for each point P of any one of said centre lines, for example the centre line 12a, it is possible to identify a corresponding point P′ belonging to the opposite centre line 12a, wherein the points P, P′ are arranged symmetrically with respect to the centre 2a of the plate 2 and are aligned according to a direction D passing through the centre 2a.

In other words, the points P, P′ belonging to the centre lines 12a; 112a of the slotted holes 12; 112 arranged at the same distance from the centre 2a of the plate 2 belong to directions that intersect each other forming equal angles and they all lie on a circumference with centre 2a, independently of the shape of the plate 2.

As regards the counterplate 6, the shaped seat 14; 114 is made in such a way that it passes through the centre 6a of the counterplate 6 and is configured in such a way that it intersects a pair of slotted holes 12; 112.

With specific reference to the embodiment that is described here below, the plate 2 is provided with two pairs of slotted holes 12; 112 and the counterplate 6 is provided with two shaped seats 14; 114 which are orthogonal to each other and each one of which is configured so as to intersect one of said pairs of slotted holes 12; 112.

It can also be observed that the shaped seats 14; 114 define two rectilinear directions 15; 115 that are orthogonal to each other and pass through the centre 6a of the counterplate 6.

Each shaped seat 14; 114 is slidingly associated with a pair of cursors 16; 116 that are visible in particular in FIGS. 4 and 5, each one of which comprises a pin 18; 118 that is configured so that it can be fitted through a corresponding slotted hole 12; 112 at the level of the area of intersection between the shaped seat 14; 114 and each corresponding slotted hole 12; 112.

Each pin 18; 118 is associated with counteracting means 34; 134 that are is placed in contact with moving means 28; 128, visible in particular in Figures from 6 to 11 and located inside the pins 18; 118, which are configured so as to move the counteracting means 34; 134 radially with respect to the pins 18; 118, as is described in greater detail below.

The device that is the subject of the invention comprises also locking means 50 suited to lock the plate 2 and the counterplate 6 to each other and manoeuvring means 60 that belong to the locking means 50 and are used by the operator to set the device 1 rotating when the flange F must be screwed to/unscrewed from the corresponding tubular element T.

At this point it should be noted that the slotted holes 12; 112 are present in the number of four and each one of them slidingly houses a corresponding pin 18; 118 so that the device of the invention is used to screw and/or unscrew unified flanges F provided with four holes that are arranged in pairs orthogonal to each other.

It is evident, however, that in a different embodiment of the invention the slotted holes can also be two, or six, or in any case a multiple of two, at the discretion of the manufacturer, depending on the configurations that the manufacturer intends to allow for the coupling with the holes Fa of the flange F. Furthermore, again in the embodiment which is described herein and to which reference is made, the slotted holes 12; 112 feature curved profiles 12′; 112′ whose curvature can have any value, provided that it is the same for all of the slotted holes.

In another embodiment of the invention that is not described herein, the slotted holes can also feature rectilinear profiles.

It should also be noted that, with particular reference to FIG. 3 and FIG. 3a, each one of the shaped seats 14; 114 has T-shaped cross section, configured so that it can slidingly house the cursors 16; 116 and provided with an open area 17; 117 from which the pin 18; 118 of the cursor 16; 116 projects.

With regard to the counteracting means 34; 134, these comprise knurled to tabs 34a; 134a that are arranged so that they project radially from slits 19; 119 made in the pins 18; 118 and are configured so as to cooperate with the moving means 28; 128 arranged inside each pin 18; 118.

These moving means 28; 128 comprise a cylindrical spindle 40; 140 that is arranged coaxially inside the corresponding pin 18; 118 and is placed in contact with elastic means 41; 141 that make its axial movement within the pin 18; 118 yielding.

With particular reference to Figures from 4 to 11, it can be observed that the pins 18; 118 are divided in pairs and comprise a first pair of pins 18, which as can be observed belong to corresponding cursors 16 inserted in the shaped seat 14, and a second pair of pins 118, each one of which belongs to a corresponding cursor 116 inserted in the respective shaped seat 114.

It can be noted that in each pin it is possible to identify a lower area 18a; 118a projecting from the respective cursor 16; 116 and an upper area 18b; 118b whose diameter is smaller than the diameter of the underlying lower area 18a; 118a, wherein each lower area 18a; 118a is separated from the corresponding upper area 18b; 118b by an annular collar 18c; 118c.

In this way the pins 18; 118 can be coupled with flanges F provided with holes Fa with diameters in two different sizes.

Furthermore, the pins 18; 118 can be divided in a first pair of pins 18, in which the slits 19 are made in the corresponding lower area 18a, and in a second pair of pins 118, in which the slits 119 are made in the corresponding upper area 118b.

Therefore, in the first pair of pins 18 the counteracting means 34 are housed in the respective lower area 18a, while in the second pair of pins 118 the counteracting means 134 are housed in the upper area 118b.

As already explained, inside the slits 19; 119 the knurled tabs 34a; 134a constituting the counteracting means 34; 134 are operated by the cylindrical spindle 40; 140 that is inserted inside each pin 18; 118.

For this purpose, each cylindrical spindle 40; 140 comprises a conical surface 42; 142 configured so that the counteracting means 34; 134 can be arranged normally projecting radially from the pin 18; 118, and a button 43; 143, at the disposal of the operator for counteracting the elastic means 41; 141, which is operated so as to radially return the counteracting means 34; 134 into the pin 18; 118.

In fact, the cylindrical spindle 40; 140 is kept normally lifted with the button 43; 143 projecting from the respective pin 18; 118 owing to the thrusting action generated by the elastic means 41; 141 that are constituted by a cylindrical spring.

At the same time, the elastic means maintain the conical surface 42; 142 of the cylindrical spindle in contact with the counteracting means 34; 134, keeping them normally projecting radially from the pin 18; 118.

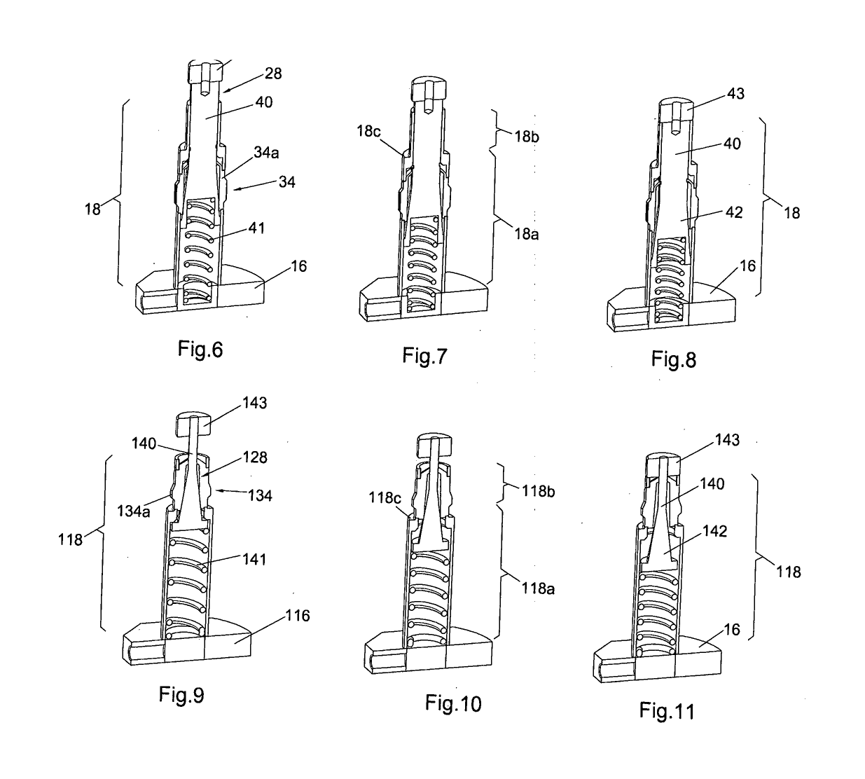

The situation described above is illustrated in the detailed FIGS. 6 and 9.

Vice versa, when the operator presses the button 43; 143 and pushes the cylindrical spindle 40; 140 downwards, overcoming the elastic thrust of the elastic means 41; 141, the conical surface 42; 142 is released from the respective counteracting means 34; 134 which therefore can radially return into the pin 18; 118.

The situation described above is illustrated in FIGS. 7, 8 and 10, 11.

As already explained, the device that is the subject of the invention comprises also locking means 50 suited to lock the plate 2 and the counterplate 6 to each other and, as can be seen, comprising a rod 4 that is configured in such a way as to define a longitudinal direction Y orthogonal to the plate 2 and the counterplate 6 and is inserted in a centre core 10 that projects from a seat 6b belonging to the counterplate 6, and a threaded knob 51 that is configured so that it can be screwed to the threaded end 4b of the rod 4 projecting from the centre core 10.

In particular, the rod 4 is arranged so that it passes through a centre hole 11 made in the centre core 10 coaxially with the centres 2a, 6a of the plate 2 and of the counterplate 6, respectively, and has a head 4a constrained to the centre 2a of the plate 2.

When the threaded knob 51 is screwed to the threaded end 4b of the rod 4 and abuts against the centre core 10, the plate 2 and the counterplate 6 are axially tightened against each other.

Once the plate 2 and the counterplate 6 have been axially tightened, the device 1 can be coupled with the flange F and set rotating.

For this purpose, the already mentioned manoeuvring means 60 are provided, which are constituted by the plane faces 61 belonging to the side surface of the centre core 10 and configured so that they can be coupled with a manoeuvring wrench of the known type available on the market.

In particular, said plane faces 61 belong to the perimeter of the polygonal profile according to which the cross section of the centre core is configured. In practice, in order to use the device 1 that is the subject of the invention, this is positioned in front of the flange F to be screwed to the tubular element T, as shown in FIG. 12.

The operator, after loosening the threaded knob 51, manually rotates the counterplate 6 with respect to the plate 2 so as to move the four cursors 16; 116 simultaneously along the shaped seats 14; 114, in such a way that the pins 18; 118, guided by the slotted holes 12; 112, move mutually, remaining orthogonal to each other in pairs until they are centred and coaxial with the four holes Fa of the flange F, as shown, in fact, in FIG. 12.

It should be stressed that during the relative rotation of the plate 2 and the counterplate 6 the pins 18; 118 move opposing each other along the two mutually orthogonal directions that are defined by the shaped seats of the counterplate 6, which are orthogonal to each other and in which the cursors 16; 116 slide.

The flanges F, as already explained, are unified flanges that are available on the market in various diameters and are all provided with four holes that are diametrically opposite in pairs and have different diameters, depending on the diameter of the flange to which they belong.

The four pins 18; 118 are then inserted in the holes Fa of the flange F and abut against them with the knurled tabs 34a or 134a, depending on the diameter of the holes themselves, as shown in FIG. 13.

Therefore, once the coupling operation has been completed, each pin 18; 118 will be housed in a corresponding hole Fa at the level of the lower area 18a; 118a or of the upper area 18b; 118b, depending on the diameter of the hole Fa, and two of said pins 18 or 118 opposing each other in pairs will be constrained to the respective hole Fa through the knurled tabs 34a or 134a.

Then, the plate 2 and the counterplate 6 are locked by tightening the threaded knob 51 and, by means of a manoeuvring wrench that is externally coupled with the faces 61 of the centre core 10, the device 1 is set rotating with the flange F associated with it and the flange is screwed to the tubular element T. Once the screwing operation has been completed, the operator presses the buttons 43 or 143 so that the knurled tabs 34a or 134a return and the latter, no more fitted in the holes Fa, allow the pins to be extracted and the entire to device 1 to be detached.

An analogous procedure is followed to unscrew a flange F already mounted on a tubular element T, after locking the tubular element T itself in a fixed clamping member, for example between the jaws of a vice.

The above description shows that the device that is the subject of the invention achieves all the set objects.

In particular, the invention achieves the object to make flange screwing and unscrewing operations simple and quick, with no need for the operator to use empirical tools.

In this way, the invention also achieves the object to make flange screwing and unscrewing operations safer, since they are carried out using standard and unified manoeuvring tools.

Furthermore, the presence of counteracting means provided with knurled tabs that abut against the holes provided in the flange makes it possible to comfortably screw and/or unscrew flanges also in positions above ground, for example to/from pipes projecting from the ceiling, always operating in safe conditions.

In the construction stage, the device that is the subject of the invention can be subjected to modifications or constructions variants that are neither described herein nor illustrated in the drawings.

It is understood, however, that these modifications or variants must all be considered protected by the present patent, provided that they fall within the scope of the following claims.

1. A device for screwing and/or unscrewing a threaded flange to/from the threaded end of a corresponding tubular element, comprising:
a plate provided with at least one pair of slotted holes configured in such a way as to define centre lines defined by a plurality of points, wherein, for each point of any one of said centre lines a corresponding point can be identified that belongs to the opposite centre line, said points being arranged symmetrically with respect to the centre of said plate and aligned along a direction passing through said centre;
a counterplate that concentrically faces and abuts against said plate and is provided with at least one shaped seat passing through the centre of said counterplate and configured so as to intersect said pair of slotted holes;
a pair of cursors slidingly fitted in said shaped seat,
each comprising a pin configured so that it can be fitted through a corresponding slotted hole at the level of the area of intersection between said shaped seat and said corresponding slotted hole;
means for counteracting associated with said pins and placed in contact with means for moving configured so as to move said means for counteracting radially with respect to said pins;
means for locking suited to lock said plate and said counterplate to each other;
means for manoeuvring belonging to said means for locking and suited to set said device rotating.

2. The device according to claim 1, wherein said plate is provided with two pairs of slotted holes and said counterplate is provided with two shaped seats that are orthogonal to each other, each one of which is configured so as to intersect one of said pairs of slotted holes and to slidingly house a pair of cursors, each comprising a pin.

3. The device according to claim 1, wherein said slotted holes have curved profiles.

4. The device according to claim 1, wherein said slotted holes have rectilinear profiles.

5. The device according to claim 2, wherein said shaped seats define two rectilinear directions that are orthogonal to each other and pass through the centre of said counterplate.

6. The device according to claim 1, wherein each one of said shaped seats has T-shaped cross section configured so that it can slidingly house said cursors and is provided with an open area from which said pin of said cursor projects.

7. The device according to claim 1, wherein said means for counteracting comprise knurled tabs radially projecting from slits made in said pins.

8. The device according to claim 7, wherein said pins comprise:
a first pair of pins, in each one of which it is possible to identify a lower area which projects from said cursor and in which said slits are provided, and an upper area whose diameter is shorter than the diameter of said underlying lower area;
a second pair of pins, in each one of which it is possible to identify a lower area projecting from said cursor and an upper area whose diameter is shorter than the diameter of said underlying lower area and in which said slits are provided.

9. The device according to claim 7, wherein said moving means for moving comprise a cylindrical spindle and means for elastic arranged in mutual contact and coaxially inside said pin.

10. The device according to claim 9, wherein said cylindrical spindle comprises:
a conical surface configured in such a way as to arrange said means for counteracting normally projecting radially from said pin;
a button at the disposal of the operator for the axial movement of said cylindrical spindle against said means for elastic for the radial return of said means for counteracting in said pin.

11. The device according to claim 1, wherein said means for locking comprise:
a rod configured in such a way as to define a longitudinal direction orthogonal to said plate and to said counterplate and passing through their centres, the head of said rod being constrained to the centre of said plate;
a centre core projecting from a seat of said counterplate and provided with a centre through hole that houses said rod;
a threaded knob configured so that it can be screwed to the threaded end of said rod projecting from said centre core in order to abut against said centre core to which said means for manoeuvring belong.

12. The device according to claim 11, wherein said means for manoeuvring are the plane faces belonging to the side surface of said centre core that are configured so that they can be coupled with a manoeuvring wrench.

13. The device according to claim 1, wherein said plate and said counterplate are circular in shape.
